(19) United States
(12) Patent Application Publication
(10) Pub. No.: US 2020/0052304 A1
(43) Pub. Date: Feb. 13, 2020

(54) ENERGY STORAGE, BIPOLAR ELECTRODE ARRANGEMENT AND METHOD

(71) Applicant: VON ARDENNE Asset GmbH & Co. KG, Dresden (DE)

(72) Inventors: Markus Piwko, Dresden (DE); Maik Vieluf, Moritzburg (DE)

(21) Appl. No.: 16/533,803

(22) Filed: Aug. 7, 2019

(30) Foreign Application Priority Data
Aug. 8, 2018 (DE) 10 2018 006 255.5
Nov. 16, 2018 (DE) 10 2018 128 898.0
Nov. 16, 2018 (DE) 10 2018 128 901.4

(51) Int. Cl. H01M 4/66; H01M 10/0569; H01M 10/0525; H01M 4/70

(52) U.S. Cl. CPC H01M 4/661; H01M 4/70; H01M 10/0525; H01M 10/0569

(57) ABSTRACT

In various embodiments, an energy storage may have: an anode and a cathode, said anode having: a foil comprising or formed from a first metal, where the first metal of the foil is one of aluminum, tin, germanium, magnesium, lead, zinc, antimony and lithium; an active anode material having a first electrochemical potential; a protection material with which the foil has been coated, where the protection material comprises a second metal other than the first metal; said cathode having: an active cathode material having a second electrochemical potential different than the first chemical potential, wherein the active anode material or the active cathode material comprises lithium.

### CROSS-CITING TO RELATED APPLICATIONS

This application claims priority to German Applications 10 2018 128 901.4 and 10 2018 128 898.0, which were filed on Nov. 16, 2018, and to German Application 10 2018 006 255.5, which was filed on Aug. 8, 2018, the entirety of each of which is incorporated herein fully by reference.

### TECHNICAL FIELD

The disclosure relates to an energy storage, to a bipolar electrode arrangement and to a method.

### BACKGROUND

Materials or components that are used in an energy storage (for example an accumulator) and are used, for example, for contact connection or for conduction of the electrical current (called “current collectors”) may be exposed to the reactive electrolyte through the active material and hence to the risk of corrosion by the electrolyte. This risk depends upon factors including the composition of the electrolyte and the material of the current collector, and rises with the reactivity of the electrolyte. In the case of a particularly aggressive electrolyte, for example an electrolyte for lithium ion-based accumulators, it is no longer possible for all materials to be directly suitable.

Corrosion may refer to a reaction of the material with its environment that results in a measurable change in the material and may lead to impairment of the function of a material or component thereof. For example, the reaction may include a lithiation of aluminum that impairs the function of the aluminum component.

A conventional lithium ion battery consists, for example, of two different electrode active material layers each having different active materials (from active anode material and active cathode material). The active electrode material layers have each been applied to a current collector and are typically separated from one another by a separator, and have been assembled facing one another with a (solid or liquid) electrolyte that fills the porosity in a cell. Only for pure solid-state cells is it possible to dispense with the separator since the solid electrolyte simultaneously acts as (electrical) separator.

The current collector used on the anode side is conventionally a copper foil (with a thickness of about 6-12 μm). On the cathode side the current collector used is conventionally aluminum foil (with a thickness of about 8-20 μm).

### SUMMARY

In various embodiments, it has been recognized that the copper foil on the anode side constitutes an upper limit to the economic viability of a lithium ion battery or cells thereof. For example, it has been recognized that the copper foil, owing to its high density, contributes a respectable proportion to the cell weight and hence constitutes an upper limit to the specific energy density of the cell based on the cell weight. Secondly, it has been recognized that copper foil entails comparatively high procurement costs. The high procurement costs arise, for example, from the fact that, firstly, the material value of copper is relatively high and, secondly, copper, owing to its material properties, may be produced as a very broad foil only at high cost. Narrower copper foil, owing to its limited width, restricts throughput, which in turn increases production costs since less electrode area may be coated per unit time.

Thus, the use of copper foil directly (via procurement costs) and indirectly (weight and process costs via limited width of the copper foil) has a high influence on the economic viability of a lithium ion battery or its cells.

In various embodiments, an energy storage, a bipolar electrode arrangement and a method that require less or no copper per energy storage are being provided. For example, substitution of the copper foil is enabled.

It is apparent that alternatives (materials/foils) to copper foil have barely been examined to date and have not become established. The cause for this lies in the high demands on the current collector, which is to have properties including high electrochemical stability, high electrical conductivity and good mechanical stability. The mechanical stability enables, for example, processing from the roll, for example in a roll-to-roll electrode manufacturing process. More particularly, aluminum has not been considered to date as a replacement for copper on the anode side since, as anode current collector, it has much too low an electrochemical stability and high corrosion. The unwanted integration of lithium ions into aluminum by means of a reaction may lead to an expansion in volume of the aluminum foil, which may lead to “crumbling” of the aluminum foil (component failure).

Aluminum does form a native oxide layer (also referred to as aluminum oxide layer). However, this is incapable of protecting the aluminum foil from corrosion in a high-energy cell in which the differential in the electrochemical potentials between anode and cathode is, illustratively, to be as great as possible. The reason for this lies in the low electrochemical stability of the native oxide layer of aluminum (aluminum oxide) toward lithium ions, such that lithium ions are conducted through the aluminum oxide layer to the aluminum. The aluminum oxide layer is, illustratively, unable to passivate the aluminum with respect to the lithium ions since it is lithiated itself for example.

Aluminum itself forms solid solutions and/or alloys with lithium, which may also form or break down through electrochemical reaction with lithium ions. For that reason, aluminum is used in a high-energy cell for example as active anode material as well. Illustratively, the aluminum, in spite of the native oxide layer of aluminum, also has an increasing tendency to integrate lithium ions (also referred to as lithiation) with rising electrical cell voltage (charging of the lithium ion battery), i.e. falling potential of the anode vs. Li/Li⁺. In the case of falling electrical cell voltage (discharging of the lithium ion battery), i.e. falling potential of the anode vs. Li/Li⁺, lithium may be extracted from the aluminum by electrochemical reactions back into the electrolyte in the form of lithium ions (also referred to as delithiation).

These electrochemical reactions of aluminum with lithium ions result in an increase in volume (in the case of lithiation of the aluminum) and a contraction in volume (in the delithiation of the aluminum), and alter the chemical composition and structural integrity of the aluminum. For that reason, aluminum (for example over and above a critical structure size (for example >1 μm)) is gradually pulverized on the anode side of a high-energy cell, meaning that it loses its previous structure and mechanical integrity. Therefore, the electrochemical reactions of the aluminum with the lithium ions from the electrolyte of a lithium ion battery, when used as anode current collector, are undesirable and lead to component failure, meaning that the aluminum current collector corrodes.

This high tendency of aluminum to react with lithium ions at a low electrochemical potential has been known since 1971 for example (A. N. Dey, Electrochemical Alloying of Lithium in Organic Electrolytes, J. Electrochem. Soc., 118 (1971) 1547-1549).

Nothing has changed as to this point of view to date. In this regard compare for example (1) “Acta Universitatis Upsaliensis”, Digital Comprehensive Summaries of Uppsala Dissertations from the Faculty of Science and Technology 1110, ISBN 978-91-554-8847-5; (2) “Li-Ion Batteries Lecture” by Mario Wachtler, published in “Winter Term 2016/17, Anode Materials” of Nov. 7/21, 2016; (3) “Lithium-Ion Batteries and Materials” by Cynthia A. Lundgren et al., published in “Springer Handbook of Electrochemical Energy (2017)”.

This behavior of aluminum in a high-energy cell is distinct from that in a low-energy cell that uses a titanate-based active anode material, for example lithium titanate (LTO). The electrochemical potential of LTO, at about 1.55 V based on lithium, is so high that no electrochemical reactions (lithiation, delithiation) of the aluminum take place with the lithium ions from the electrolyte, and so aluminum is usable as current collector on the anode side as well. However, such a low-energy cell is characterized by a low energy density, and so it is unsuitable for many end uses, for example electrical mobility or other mobile devices.

Illustratively, every material has an electrochemical stability window in which this material, if appropriate also by virtue of a native oxide surface or a passivation film on the material that has been formed in situ in the cell, is slow to react and/or electrochemically stable. Illustratively, the electrochemical stability window denotes the voltage or potential range with respect to a reference electrode in which the material is slow to react and/or electrochemically stable to the various reactants to which it is exposed.

Illustratively, the electrochemical stability window of aluminum is outside the voltage or potential range in which anodes for high-energy lithium ion batteries are operated, since aluminum is electrochemically stable with respect to Li/Li⁺ in the conventional electrolytes containing lithium ions inter alia only within a potential range from about 1.5 volts (V) to about 4.5 volts (V). However, a high-energy cell uses, on the anode side, an active anode material which is operated at a potential versus Li/Li⁺ of less than about 1.0 V, for example of about or close to 0.0 volts. Therefore, aluminum as current collector is conventionally used only on the cathode side of a high-energy source.

The (cell) voltage here may be the measurable electrical voltage of the entire cell, i.e. anode versus cathode (optionally with current flow). The potential (for example of an electrode) may be based on a reference electrode, and may be reported with respect thereto as voltage (i.e. as the difference in the two potentials). The potential (for example of an electrode) may be measured without current flow through the reference electrode. Reference electrodes chosen are typically materials having constant, well-known electrochemical potential.

The potential of an electrode for a lithium ion battery changes with the state of charge (degree of lithiation of the anode or the cathode). The anode of a high-energy cell in unlithiated form (i.e. at the start of the charging curve) may be at about 1.0 V (for silicon) or at about 0.5 V (for graphite). The end of the charging curve may be at about 10 mV. An exception is lithium metal which, depending on the current density, is always at about 0 V.

In various embodiments, an energy storage, a bipolar electrode arrangement and a method are provided, which enable use of aluminum as current collector on the anode side of a high-energy cell. This increases the specific energy (for example based on weight) (in Wh/kg, watt hours per kg) or energy density (for example based on volume) (in Wh/l, watt hours per liter) of the high-energy cell and/or reduces the production costs thereof.

It has been illustrated in various embodiments that it is sufficient to provide the aluminum foil with a protection layer having higher electrochemical stability toward the electrolyte containing lithium ions than the native oxide of aluminum (aluminum oxide). Illustratively, the aluminum foil provided with the protection layer is slow to react and/or electrochemically stable to the electrolyte containing lithium ions, such that it may be used as current collector in a high-energy cell without breaking up too quickly and/or corroding.

In various embodiments, an energy storage may have: an anode and a cathode, said anode having: a foil including aluminum; an active anode material (e.g. electrochemically active anode material) having a first electrochemical potential; a protection material with which the foil has been coated, wherein the protection material includes a metal other than aluminum; said cathode including: (for example a foil including a metal,) an active cathode material (e.g. electrochemically active cathode material) having a second electrochemical potential other than the first chemical potential; where the active anode material or the active cathode material includes lithium (and optionally where the active cathode material include sulfur).

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiment. In the following description, various embodiments are described with reference to the following drawings, in which:

FIGS. 1A, 1B and 7 each show a method according to various embodiments in a schematic flow diagram;

FIGS. 2, 3, 4 and 6 each show an energy storage in various embodiments in a schematic side view or a schematic cross-sectional view; and

FIG. 5 shows a bipolar electrode arrangement in various embodiments in a schematic side view or a schematic cross-sectional view.

### DETAILED DESCRIPTION

In the following detailed description, reference is made to the accompanying drawings, which form part of this description and in which specific embodiments in which the disclosure may be carried out are shown for purposes of illustration. In this respect, directional terminology such as for instance “at the top”, “at the bottom”, “at the front”, “at the rear”, “front”, “rear”, etc. are used with reference to the orientation of the figure(s) described. Since components of embodiments may be positioned in a number of different orientations, the directional terminology serves for purposes of illustration and is in no way restrictive. It goes without saying that other embodiments may be used and structural or logical changes made without departing from the scope of protection of the present disclosure. It goes without saying that the features of the various embodiments described herein by way of example may be combined with one another, unless otherwise specifically stated. The following detailed description is therefore not to be interpreted in a restrictive sense, and the scope of protection of the present disclosure is defined by the appended claims.

In the course of this description, the terms “connected” and “coupled” are used for describing both a direct connection and an indirect connection (for example ohmic and/or electrically conductive, e.g. an electrically conductive connection) and both a direct coupling and an indirect coupling. In the figures, identical or similar elements are provided with identical designations, wherever appropriate.

In various embodiments, the term “coupled” or “coupling” may be understood in the sense of a (for example mechanical, hydrostatic, thermal and/or electrical) connection and/or interaction, for example a direct or indirect connection and/or interaction. Multiple elements may be coupled to one another, for example, along a chain of interaction, along which the interaction (e.g. a signal) may be transmitted. For example, two mutually coupled elements may exchange an interaction with one another, for example a mechanical, hydrostatic, thermal and/or electrical interaction. In various embodiments, “coupled” may be understood in the sense of a mechanical (e.g. physical) coupling, for example by means of a direct physical contact. A coupling may be configured to transmit a mechanical interaction (e.g. force, torque, etc.).

An energy storage cell (also referred to as cell) may be understood to mean the smallest voltage-generating unit of an energy storage. The energy storage cell provides the base potential of the energy storage, which, according to the interconnection, provides a voltage equal to the base potential or a voltage that may be a multiple of the base potential. The or each energy storage cell may have a (for example exactly one) active anode material layer on a current collector and a (for example exactly one) active cathode material layer on a current collector, which are separated by an electrically insulating separator but connected to one another by an electrolyte that conducts lithium ions (for example by means of a cavity in which the electrolyte may have been or may be accommodated).

In various embodiments, the active cathode material (also referred as to cathode-active material) described herein may have been provided or may be provided as a layer or coating (also referred to as the active cathode material layer). Alternatively or additionally, the active anode material (also referred as to anode-active material) described herein may have been provided or may be provided as a layer or coating (also referred to as the active anode material layer).

The electrochemical stability of a first material with respect to one or more than one second material (for example a mixture of two or more second materials) may depend on the nature of the respective material combination and may generally be based on exactly one material combination. The electrochemical stability of the first material with respect to the second material, which may optionally serve as reference electrode for the reporting of the electrochemical stability, may be understood to mean the reciprocal of the reaction rate of these with one another. The same applies in analogy when the first material is exposed to the mixture of two or more second materials (referred to more generally hereinafter as material combination).

The reaction rate indicates the amount of identical reactions in molar amount per unit time and volume (e.g. mol/(s·m³)) by means of the material combination. A high electrochemical stability results in high reaction inertness (meaning that the material combination barely interreacts, if at all). Electrochemical stability may depend upon factors including the electrochemical potential of the material combination (for example the difference in potential from one another, which may be reported as the voltage) and on the materials of the material combination themselves. Every material has a LUMO (“lowest unoccupied molecular orbital”) and a HOMO (“highest occupied molecular orbital”) within which it is electrochemically stable, i.e. may not release or absorb any electrons. Depending on whether the external potential (energy level) is lower than the LUMO and/or higher than the HOMO, a reduction process (electron absorption) or oxidation process (electron release) may set in, which may lead to breakdown and/or corrosion of the material. According to the relationship, electrochemical stability may include the formation of one or more than one passivation layer which may then increase the electrochemical stability above LUMO or HOMO, which results in a greater potential range within which the material is stable.

The range of electrochemical potential of the first material within which the first material is electrochemically stable with respect to the second material or is in a material combination is also referred to as electrochemical stability window. Within the electrochemical stability window, the reaction rate may, for example, be less than 0.1% of the reaction rate outside the electrochemical stability window. In other words, electrochemical stability is based on a specific material combination (for example herein on a current collector and an electrolyte containing lithium ions), while the electrochemical stability window is generalized and may indicate electrochemical stability based on the electrochemical properties of the environment. Electrochemical stability may also relate to a mixture of two or more materials (for example a current collector in an electrolyte). Usually, the electrochemical stability window is reported for electrolytes. For example, an electrolyte may include a mixture of two or more materials (also referred to as electrolyte constituents), such that not only the reactions of exactly one electrolyte constituent of the electrolyte with electrons at one potential but also the interaction with the other electrolyte constituents may limit the electrochemical stability window.

Since the potential itself is not measurable, it is always based on a potential of a reference electrode (e.g. lithium, hydrogen, etc.). This is analogously also true of the electrochemical stability window, which may be calibrated, for example, to the electrochemical potential of lithium (for example electrochemically stable from 1.0-0.0 V with respect to Li/Li⁺). No voltage may be assigned to lithium itself, just a potential, i.e., for example, the potential of lithium with respect to lithium (in that case corresponding to 0 V versus Li/Li+). Based on hydrogen, the potential of lithium may be reported, for example, as “−3.04 V versus H2/H+”.

When Li is measured against lithium in a cell (at zero current) (Li versus Li), it is possible to measure a cell voltage of 0 V. In that case, the potential is formally identical and the voltage is zero. Typically, especially in the case of a current flow, however, cell voltage is different than the potential of an electrode/a material (owing to what are called overpotentials). Viewed in formal terms, the reference electrode or potential thereof (lithium, hydrogen, etc.) on which the electrochemical stability window is based is a question of conversion. For example, −3.04 V versus hydrogen (H) as reference may be converted to lithium as reference.

Electrochemical stability may be ascertained, for example, by means of a cyclic voltammetry measurement. In cyclic voltammetry, a rising potential and subsequently a falling potential is applied to a working electrode (consisting, for example, of the first material, the electrochemical stability of which versus a second, further material or a material combination is to be determined) in an electrolyte solution (for example containing the second material). The potential of the first material is determined accurately by means of what is called a reference electrode. The current that flows through the working electrode is detected as a function of the voltage and gives an indication of the type and number of electrochemical reduction and oxidation reactions that proceed. A peak in the current consequently shows the running of an electrochemical reaction and hence, in the case of an unwanted reaction, electrochemical instability. According to the application and type of material, the current measured must not exceed a defined threshold value. The minimum (lower limit) and maximum (upper limit) potential from which the threshold value is exceeded defines the electrochemical stability window.

In various embodiments, a foil (an aluminum foil or an aluminum-coated foil) may have a thickness (i.e. transverse to the lateral extent of the foil) of less than 40 μm, for example less than about 35 μm, for example less than about 30 μm, for example less than about 25 μm, for example less than about 20 μm, for example less than about 15 μm, for example less than about 10 μm, for example less than about 5 μm, for example within a range from about 3 μm to about 20 μm, for example about 5 μm or, for example, about 15 μm.

The foil may have, for example, a width, i.e. an extent in the direction of its lateral extent (for example at right angles to transport direction), within a range from about 0.01 m to about 7 m, for example within a range from about 0.1 m to about 3 m, for example within a range from about 0.3 m to about 1 m, and also a length, i.e. an extent in the direction of its lateral extent transverse to the width (for example parallel with respect to transport direction), of more than 0.01 m, for example more than 0.1 m, for example more than 1 m, for example more than 10 m (in that case the foil 302 may be transported, for example, from roll to roll), for example more than 50 m, for example more than 100 m, for example more than 500 m, for example more than 1000 m or several thousand meters.

In various embodiments, the foil may include a laminate of at least one plastic and a first metal, where the first metal of the foil is one of aluminum, tin, germanium, magnesium, lead, zinc, antimony and lithium. For example, the foil may include or have been formed from a polymer film coated (for example on one or two sides) with the first metal. Alternatively, the foil may have been formed from the first metal. For example, the foil may consist to an extent of more than 50 at % of the first metal, for example to an extent of more than 70 at % of the first metal, or, for example, to an extent of more than 90 at % of the first metal.

In the context of this description, an electrochemical potential, when reported in a voltage (for example in volts), may be regarded as being based on the electrochemical potential of lithium, e.g. Li/Li+.

In the context of this description, a metal (also referred to as metallic material) may more generally include (or have been formed from) at least one metallic element (i.e. one or more metallic elements), for example at least one element from the following group of elements: copper (Cu), iron (Fe), titanium (Ti), nickel (Ni), silver (Ag), chromium (Cr), platinum (Pt), gold (Au), magnesium (Mg), aluminum (Al), zirconium (Zr), tantalum (Ta), molybdenum (Mo), tungsten (W), vanadium (V), barium (Ba), indium (In), calcium (Ca), hafnium (Hf), or samarium (Sm). In addition, a metal may include or have been formed from a metallic compound (e.g. an intermetallic compound or an alloy), for example a compound of at least two metallic elements (for example from the group of elements), for example bronze or brass, or, for example, a compound of at least one metallic element (for example from the group of elements) and at least one nonmetallic element, for example steel.

An electrolyte may refer to a substance or substance mixture that may conduct lithium ions, i.e. is Li ion-conductive. The electrolyte may include or have been formed from solid or liquid constituents. For example, the electrolyte may include or have been formed from one or more than one of the following constituents: a liquid electrolyte (e.g. conductive salt with solvent and optional additives), a polymer electrolyte, an electrolyte based on an ionic liquid, and/or a solid-state electrolyte. Optionally, the electrolyte may include a mixture of various constituents. Alternatively or additionally, within a cell, it is possible to use two or more electrolyte types and/or constituents alongside one another.

In various embodiments, the electrolyte may include at least one of the following: salt (such as LiPF₆ (lithium hexafluorophosphate), LiBF₄ (lithium tetrafluoroborate)), anhydrous aprotic solvent (e.g. ethylene carbonate, diethyl carbonate, etc.), polyvinylidene fluoride (PVDF), polyvinylidene fluoride-hexafluoropropene (PVDF-HFP), Li₃PO₄N lithium phosphate nitride.

In various embodiments, a foil processed by means of a method as described herein may be used in an energy storage, for example a battery, an accumulator, e.g. a lithium ion accumulator. In various embodiments, the foil may be used in one or every electrode (e.g. anode and/or cathode) of the energy storage.

An energy storage may include or have been formed from, for example, a specific lithium ion accumulator type, for example a lithium-sulfur accumulator, a lithium-nickel-manganese-cobalt oxide accumulator, a lithium-nickel-cobalt-aluminum oxide accumulator, a lithium-nickel-manganese oxide accumulator, a lithium-polymer accumulator, a lithium-cobalt dioxide accumulator (LiCoO₂), a lithium-air accumulator, a lithium-manganese dioxide accumulator, a lithium-manganese oxide accumulator, a lithium-iron phosphate accumulator (LiFePO₄), a lithium-manganese accumulator, and/or a lithium-iron phosphate accumulator.

In various embodiments, the protection layer may have a thickness (layer thickness, i.e. transverse to the lateral extent of the foil) within a range from about 2 nm to about 1 μm, for example within a range from about 10 nm to about 200 nm or within a range from about 5 nm to about 500 nm, for example within a range from about 100 nm to about 200 nm. Alternatively or additionally, the protection layer may include or have been formed from a second metal different than the first metal. For example, the protection layer may consist to an extent of more than 50 at % of the second metal, for example to an extent of more than 70 at % of the second metal, or, for example, to an extent of more than 90 at % of the second metal.

An active material may, in various embodiments, have been provided or be provided as part of the active material layer. In general, this need not necessarily be present or else may have been provided or be provided in some other way and may therefore be referred to more generally hereinafter as active material. What has been described in respect of the active material may also be analogously applicable to an active material layer, or vice versa.

An active material (for example the active anode material and/or the active cathode material), for example an active material layer, may generally have a high specific surface area, for example greater than that of the foil and/or the protection layer. For this purpose, the active material, e.g. the active material layer, may be porous, for example, i.e. have pores or other voids, for example a network of mutually connected pores and/or passages. For example, the active material may have a porosity within a range from about 10% to about 80% (for example within a range from about 20% to about 40% or to about 80%). Alternatively, the active anode material may have a compact lithium layer (e.g. a lithium metal anode). For example, it is possible to use a pore-free lithium metal layer as active anode material.

In various embodiments, an active material may have a thickness (layer thickness, i.e. transverse to the lateral extent of the foil) within a range from about 5 μm to about 500 μm, for example within a range from about 5 μm to about 100 μm.

For example, the active material may have been provided or be provided as part of a mixture (for example as part of an active material layer, such as active anode material layer and/or active cathode material layer), where the mixture may include or have been formed from: the active material: one or more than one conductive additive (for example conductive black, carbon nanotubes and/or carbon fibers), and/or one or more than one binder material (e.g. polytetrafluoroethylene, polyethylene oxide, styrene-butadiene rubber, carboxymethyl celluloses, polyvinylidene fluoride, etc.). The binder material may include or have been formed from a polymer for example. The active material may be the active anode material or the active cathode material.

In the context of this description, the active anode material may include or have been formed from, for example, one or more than one of the following materials: carbon (for example in a carbon modification, such as graphite, hard carbon, or the like), silicon, lithium, tin, zinc, aluminum, germanium, magnesium, lead, antimony; or one or more than one transition metal oxide, one or more than one transition metal oxide sulfide, one or more than one transition metal oxide nitride, one or more than one transition metal oxide phosphide, one or more than one transition metal oxide fluoride, or more generally a transition metal compound AₓB_{y} (where A is one of Fe, Co, Cu, Mn, Ni, Ti, V, Cr, Mo, W, Ru and B is one of O, S, P, N, F; for example Cr₂O₃). Alternatively or additionally, the active anode material may be metallic, for example metallic lithium and/or metallic aluminum. More generally speaking, the active anode material may be a material that lithiates, i.e. reacts chemically with lithium (for example a lithium compound), and/or intercalates lithium. The active anode material may have a potential versus Li of less than about 2 V, for example less than about 1.5 V.

In the context of this description, the active cathode material may include or have been formed from, for example, one of the following materials: lithium-iron phosphate (LFP), lithium-nickel-manganese-cobalt oxide (NMC), lithium-cobalt oxide (LCO), lithium-manganese oxide (LMO), lithium-nickel-cobalt aluminum oxide (NCA), lithium-nickel-manganese oxide (LNMO), sulfur, and/or oxygen.

The energy storage provided may have one or more than one high-energy cell. A high-energy cell uses, for example, on the anode side, an active anode material having an electrochemical potential with respect to lithium of less than about 1 V, for example of less than about 0.5 V, for example within a range from about 0 V (or −0.5 V) to about 0.5 V. The active anode material of the high-energy cell may include or have been formed from, for example, carbon (for example graphite, hard carbon), silicon, lithium, tin, zinc, aluminum, germanium, magnesium, lead, antimony or transition metal oxides, sulfides, nitrides, phosphides, fluorides or a transition metal compound AₓB_{y} (where A is one of Fe, Co, Cu, Mn, Ni, Ti, V, Cr, Mo, W, Ru and B is one of O, S, P, N, F; for example Cr₂O₃).

The description which follows is based on aluminum for better comprehensibility. Rather than aluminum, this description may alternatively be applicable in analogy to tin, germanium, magnesium, lead, zinc, antimony or lithium. Foils made of these materials, for example metal foils made of these materials, and/or polymer films coated with these materials, may, for example, be particularly inexpensive, have low weight and/or have particularly good passivatability, and/or generally be of good suitability.

In various embodiments, the anode may include a foil including aluminum. The aluminum in the foil may have been provided or be provided as elemental aluminum or in an alloy. Alternatively or additionally, the aluminum may have been doped or may be doped, for example with specifically introduced doping elements. The alloy and/or the doping of the aluminum may serve, for example, to adjust the mechanical properties.

Reference is made hereinafter to lithium for simpler understanding, for example in conjunction with a lithium ion energy cell. What has been described may also be analogously applicable to a lithium-sulfur energy cell (Li/S energy cell). After assembly, the cathode of the lithium-sulfur energy cell is free of lithium. For example, in that case, the anode of the lithium-sulfur energy cell may include lithium.

Reference is made hereinafter, for simpler understanding, to the active material (e.g. active cathode material or active anode material). The active material may generally have been provided or be provided as part of a mixture (for example of a coating composed of the mixture), as described in more detail hereinafter. What has been described for the active material may also be analogously applicable to the mixture (for example an active material layer of the mixture) that includes the active material, or vice versa.

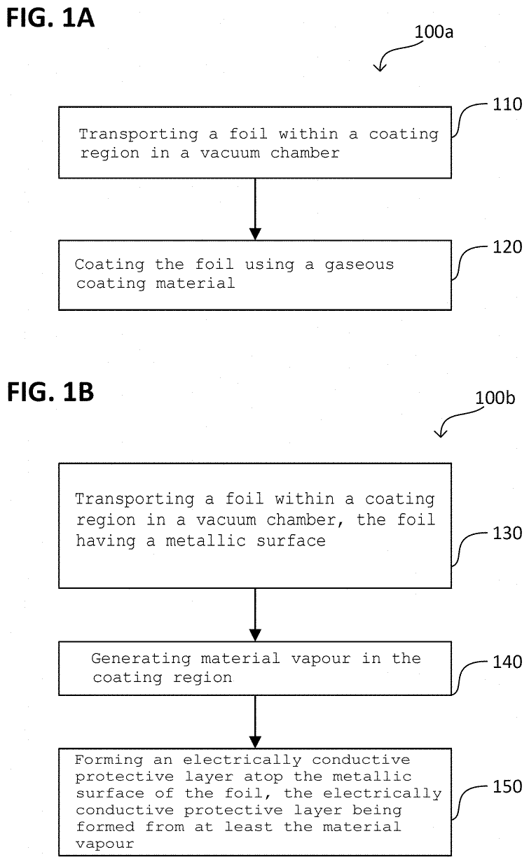

FIG. 1A illustrates a method 100a in various embodiments in a schematic flow diagram.

The method 100a may include, in 110: transporting of a foil within a coating region in a vacuum chamber, where the foil includes aluminum; and may include, in 120: coating of the foil with a protection layer using a gaseous coating material.

In various embodiments, a vacuum-based method for (for example optionally single-sided or double-sided) deposition of the protection layer is provided. This method may be applied, for example, to thin aluminum foils (Al foils) or other foils having an aluminum surface, for example to an aluminum-finished polymer film. In various embodiments, by means of the method, one or more than one electrically conductive current collector having low surface contact resistance which is chemically resistant to lithium is provided. The vacuum-based method may, for example, be a chemical vapor deposition (CVD) and/or a physical vapor deposition (PVD). Alternatively, an electrolytic deposition may also be effected.

In various embodiments, a method of producing thin, corrosion-resistant and electrically conductive foils with low surface contact resistance is provided for use as current collector and/or output conductor for high-energy cells in an energy storage, for example for lithium ion batteries.

For this purpose, the method, in various embodiments, may also include: optionally removing a surface layer (for example at least the native passivation layer) of the foil (for example prior to the coating) for at least partial exposure of the metallic aluminum in the foil, so as to form a (for example exposed) aluminum surface. The surface layer may be removed using a plasma, i.e. by means of what is called plasma etching.

In various embodiments, the gaseous coating material (also referred to as material vapor) may include or have been formed from the second metal (e.g. Ni, Ti or Cu). For example, the gaseous coating material may include or have been formed from titanium. Using the gaseous coating material including or formed from at least titanium, a titanium layer, for example, may have been formed or be formed as protection layer.

In various embodiments, the protection layer may have a geometric space filling, i.e. the ratio of apparent density to true density, of more than about 80%, for example more than about 90%, for example about 100%. In other words, the microstructure of the protection layer may have a proportion of pores or voids in the total volume (for example of a coating) of less than about 20%, for example less than about 10%, for example less than about 5%, for example less than about 1%.

Illustratively, the protection layer is then essentially free of pores or voids.

The protection layer may increase the chemical stability of the foil to lithium, for example for use in a high-energy cell.

FIG. 1B illustrates a method 100b in various embodiments in a schematic flow diagram.

In various embodiments, the coating of the foil with a protection layer 100b may include, in 130: transporting of a foil within a coating region in a vacuum chamber, where the foil has a metallic surface of aluminum or a native oxide layer of aluminum. The method 100b may also include, in 140: producing material vapor (also referred to as gaseous coating material) in the coating region. The method 100b may also include, in 150: forming an electrically conductive protection layer (also referred to as contact layer) on the metallic surface or the native oxide layer of the aluminum in the foil, wherein the electrically conductive protection layer is formed from at least the material vapor.

Optionally, the metallic surface may have been provided or may be provided by removing the native oxide layer, for example by means of plasma etching.

In various embodiments, the coating of the foil with a protection layer may be effected by means of a physical vapor deposition (PVD).

In various embodiments, the film that has been coated with the protection layer may also have been provided or be provided in some other way.

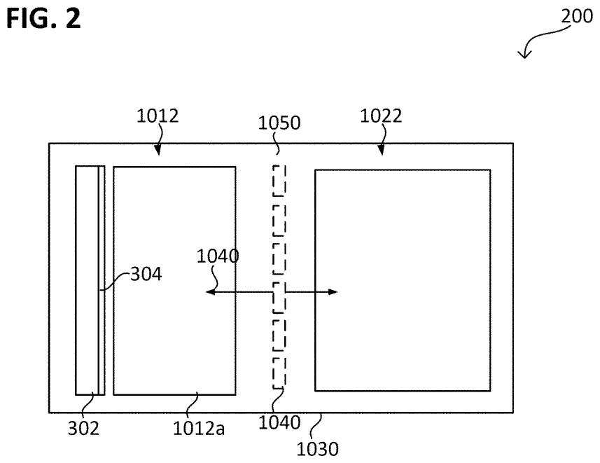

FIG. 2 illustrates an energy storage having one or more than one energy storage cell 200, in various embodiments in a schematic side view or a schematic cross-sectional view.

The energy storage may include one or more than one energy storage cell 200, where the or each energy storage cell 200 may have been or may be arranged, for example stacked, periodically for example (for example in stacked form or in coiled form) in the energy storage. For example, the energy storage may be a round energy storage, a pouch energy storage, or a prismatic energy storage.

Optionally, the or each energy storage cell 200 may include a separator 1040 as described in more detail hereinafter. For example, the or each energy storage cell 200 may include a liquid electrolyte and the separator for electrical separation of the electrodes. Alternatively, the or each energy storage cell 200 may include a solid electrolyte configured for electrical separation of the electrodes, in which case the separator may be omitted, or may be necessary in the case of some types of solid electrolyte.

The energy storage, for example the or each energy storage cell 200, may, in various embodiments, have an anode 1012 that has a first electrochemical potential. The anode 1012 may include a foil 302 (for example an electrically conductive foil 302) that includes the aluminum.

In addition, the anode 1012 may include a protection material 304 with which the foil 302 has been coated (also referred to as protection layer 304), where the protection material includes a metal other than aluminum. The protection layer 304 may be in physical contact, for example, with the aluminum in the foil 302.

In addition, the anode 1012 may have an active anode material layer 402 arranged atop the protection layer 304, for example in physical contact therewith. The active anode material layer 402 may include or have been formed from the active anode material 1012a.

The protection layer 304 may be an electrically conductive layer, for example in the form of a contact layer disposed between the foil 302 and the active anode material 1012.

In addition, the energy storage, for example the or each energy storage cell 200, may have a cathode 1022 that has a second electrochemical potential.

An electrical voltage may develop between the anode 1012 and the cathode 1022 (also referred to more generally hereinafter as electrodes), for example when the energy storage has been or is charged, which corresponds roughly to the differential between the first chemical potential and the second chemical potential. Such an energy storage may have one or more than one such energy storage cell 200 (for example connected in parallel to one another or in series with one another).

An electrical potential may develop between anode and cathode (both in the charging and discharging operation, and also in the power-off state) when the electrodes are connected via an ion-conducting medium 1040 (e.g. electrolyte 1040, in solid or liquid form).

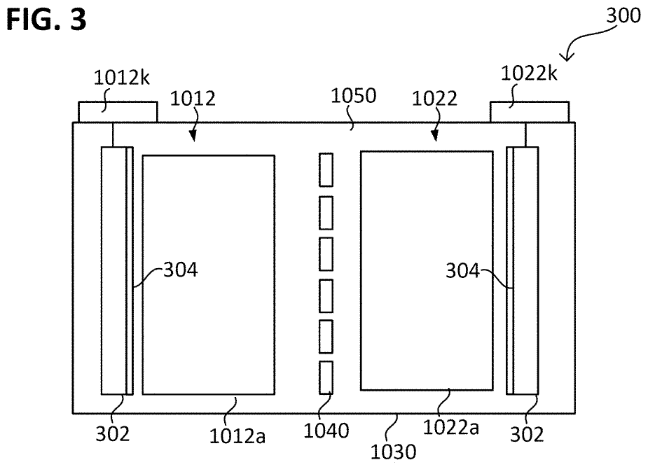

Illustratively, the foil 302 may function as current collector or current conductor for provision or tapping of the electrical charges that are stored or released at the anode 1012 in the electrochemical reduction or oxidation reactions, for example when the energy storage is being charged or discharged. The lithium ions that move between the anode 1012 and the cathode 1022 in the (liquid or solid) electrolyte 1050 (ion exchange) may bring about a conversion of stored chemical energy (for example when the energy storage has been charged) to electrical energy, where the chemical energy provides an electrical potential between the electrodes 1012, 1022 and/or between the contact connections 1012k, 1022k coupled thereto (cf. FIG. 3).

The electrical energy may be the product of current, potential and time (i.e. E=U*I*t). The potential U is found from the electrochemical potentials of anode/cathode and is variable with the charge state of the cell. The current I may be provided (discharging) or consumed (charging), and is coupled to the spatial flow of lithium ions (Li⁺+e⁻←→Li). The time t corresponds to the duration with which current is being provided or consumed, i.e. for how long discharging or charging is being effected, for example a current-consuming load is attached.

In various embodiments, the energy storage, for example the or each energy storage cell 200, may provide an average electrical potential of more than about 3.5 volts (V), for example of more than about 3.7 V, for example of more than about 4 V. The average electrical potential may correspond to the average value between the potential in the discharged state and the potential in the discharged state of the energy storage cell 200, i.e. be a charge cycle-averaged potential.

The potential of the or each energy storage cell 200 may vary depending on the charge state. If the cell has been discharged, the potential may be low, for example about 3.0 V in the case of an LIB energy storage cell 200 or within a range from about 2.5 V to about 3.5 V. If the cell has been charged, the potential may, illustratively, be high, for example about 4.3 V in the case of an LIB energy storage cell 200, for example within a range from about 3.7 V to about 5.0 V.

In general, the or each energy storage cell 200 (for example an Li/S energy storage cell 200) may provide a cell potential of about 1.8 V or more in the discharged state and of about 2.6 V in the charged state. A lithium-air energy storage cell 200 may provide a potential of about 2.0 V in the discharged state and up to about 4.8 V in the charged state.

For example, for an electrical voltage of more than about 3.5 V (for example than 4 V), a protection layer 304 may be required to inhibit or prevent an electrochemical reaction of the aluminum in the foil 302 with the lithium ions or other constituents of the electrolyte 1050.

Optionally, the film 302 may have been coated or be coated with the protection layer on either side.

The active anode material 1012a may include or have been formed for example from graphite (or carbon in another carbon configuration), include or have been formed from nanocrystalline and/or amorphous silicon, include or have been formed from aluminum, or include or have been formed from tin dioxide (SnO₂).

In various embodiments, the active anode material (for example in the form of a liquid phase, i.e. dissolved in a solvent) and/or one or more than one additional constituent of the active anode material layer 402 (for example one or more than one binder, and/or one or more than one conductive additive) may have been applied or may be applied by means of a ribbon coating system to the film 302 having a protection layer 304, for example by means of a liquid phase deposition, for example by means of a spray coating operation, a curtain coating operation, a comma-bar coating operation and/or a slot-die coating operation.

Alternatively or additionally to the liquid phase, it is possible to use a dry coating operation. Then one or more than one (for example all) electrode constituent(s) may be mixed in dry form and then applied (for example by means of spray coating and/or powder application and calendering).

Optionally, in a subsequent drying process (in which the foil 302 having the protection layer 304 and the still solvent-containing active anode material layer 402 is heated), remaining solvent is extracted from the active anode material layer 402.

The forming of the energy storage may include: applying the active anode material 1012a (for example as a coating and/or part of the active anode material layer 402) to the foil 302 coated with the protection layer 402 to form an anode 1012 that has a first electrochemical potential; combining the anode 1012 with the cathode 1022 (optionally separated by means of a solid electrolyte 1050 and/or a separator), where the cathode 1022 has the second electrochemical potential; and optionally encapsulating the anode 1012 and the cathode 1022. Optionally, a liquid electrolyte 1050 may be introduced into the energy storage cell prior to encapsulation thereof.

Optionally, the forming of the energy storage may further include: forming a contact connection for contacting of the foil 302 of the anode 1012. For example, the forming of the energy storage may further include: forming an additional contact connection for contacting of the cathode 1022.

The energy storage, for example the or each energy storage cell 200 of the energy storage, may be a high-energy storage. The high-energy storage may provide an average electrical voltage of more than 4 volts per cell. The cell voltage may be variable and depend on the cell system. For example, a Li/S energy storage cell 200 may provide a high specific energy coupled with a low average cell potential. The active material absorbs more lithium, which leads to a higher capacity. The energy may correspond to the product of potential and capacity.

A high-energy cell may, illustratively, provide a high specific energy, for example about 100 Wh/kg or more, e.g. 150 Wh/kg or more, e.g. 200 Wh/kg. Alternatively or additionally, a high-energy cell may provide a high energy density, for example 300 Wh/l or more, for example 400 Wh/l or more, for example 500 Wh/l or more.

For example, the foil 302 may be an aluminum foil having a thickness within a range from about 9 micrometers (μm) to about 20 μm.

Moreover, the energy storage, for example its or each energy storage cell 200, may have an encapsulation 1030 that surrounds the anode 1012 and the cathode 1022.

FIG. 3 illustrates an energy storage having, for example, one or more than one energy storage cell 300, in various embodiments in a schematic side view or a schematic cross-sectional view.

In various embodiments, the anode 1012 may have a first foil 302 (also referred to as anode foil 302) and the cathode 1022 may have a second foil 302 (also referred to as cathode foil 302).

In addition, the cathode 1022 may include the active cathode material 1022a, for example as part of an active cathode material layer 404. The active cathode material 1022a (for example the active cathode material layer 402) may have been disposed or be disposed atop the cathode foil 302. The active cathode material 1022a may provide the second chemical potential.

The active anode material 1012a may differ from the active cathode material 1022a, for example in terms of electrochemical potential or chemical composition.

The active anode material 1022a may include or have been formed from, for example, lithium-iron phosphate (LFPO) (for example in a lithium-iron phosphate energy storage), include or have been formed from lithium-manganese oxide (LMO) (for example in a lithium-manganese oxide energy storage) or include or have been formed from lithium-nickel-manganese-cobalt oxide (NMC) (for example in a lithium-nickel-manganese-cobalt oxide accumulator).

Optionally, the cathode foil 302 may include aluminum.

Optionally, the cathode 1022 may include a protection material 304 (also referred to as cathode foil protection material) with which the cathode foil 302 has been coated (also referred to as cathode foil protection layer 304), where the cathode foil protection material 304 includes a metal other than aluminum. The cathode foil protection layer 304 may be in physical contact, for example, with the aluminum in the cathode foil 302.

The cathode foil protection layer 304 may be an electrically conductive layer, for example in the form of a contact layer disposed between the cathode foil 302 and the active cathode material 1022a (for example the active cathode material layer 404), for example in physical contact therewith.

Optionally, the cathode foil 302 may have been coated or be coated with the cathode foil protection layer 304 on either side.

In addition, the energy storage may have a first contact connection 1012k which is in electrical and/or physical contact with and/or at least coupled to the anode 1012, and is connected in an electrically conductive manner to the anode foil 302 for example. The first contact connection 1012k may have an exposed surface.

In addition, the energy storage, for example the or each energy storage cell 300, may have a second contact connection 1022k which is in electrical and/or physical contact with and/or at least coupled to the cathode 1022, and is connected in an electrically conductive manner to the cathode foil 302 for example. The second contact connection 1022k may have an exposed surface.

The electrical potential may be tapped between the first contact connection 1012k and the second contact connection 1022k, for example when the energy storage has been charged, which corresponds roughly to the differential between the first chemical potential and the second chemical potential.

Optionally, the energy storage may have a separator 1040. The separator 1040 may separate the anode 1012 and the cathode 1022, in other words the negative and positive electrode, spatially and electrically from one another. However, the separator 1040 may be permeable to lithium ions that move between the anode 1012 and the cathode 1022 through the solid or liquid electrolyte 1050. The lithium ions that move between the anode 1012 and the cathode 1022 may bring about a conversion of stored chemical energy (for example when the energy storage 1100 has been charged) to electrical energy, where the chemical energy provides an electrical voltage at the contact connections 1012k, 1022k, as described above.

The separator 1040 may include or have been formed from a microporous plastic (for example polypropylene or polyethylene, or a multilayer combination thereof), and/or the separator may include or have been formed from a nonwoven, for example from glass fibers. Optionally, the separator may contain embedded ceramic particles or a ceramic coating (for example a ceramic-functionalized separator).

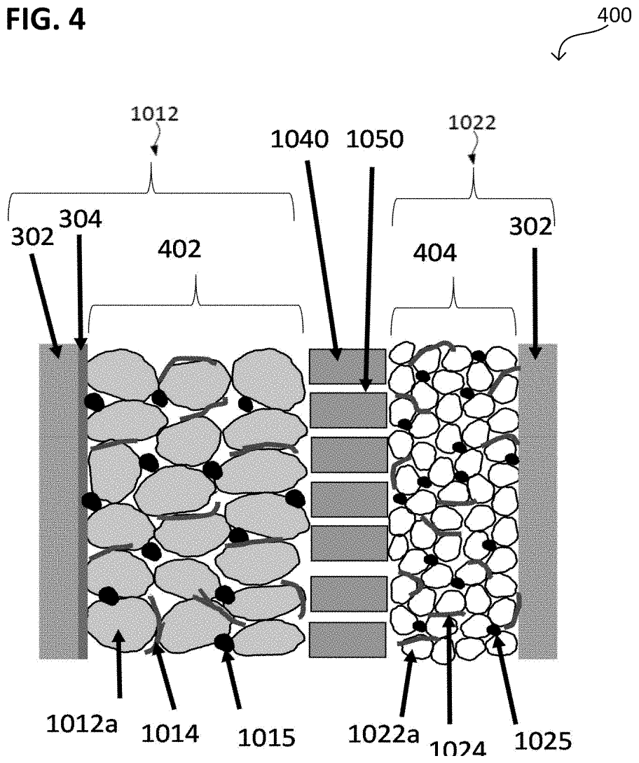

FIG. 4 illustrates an energy storage having, for example, one or more than one energy storage cell 400, in various embodiments in a schematic side view or a schematic cross-sectional view.

The energy storage, for example the or each energy storage cell 400, may include: an aluminum-containing anode foil 302 (e.g. an aluminum foil 302), a (fluid-tight and/or lithium ion-tight) protection layer 304 in physical contact with the aluminum foil 302, a porous active anode material layer 402 (having, for example, a granular active anode material 1012a, one or more than one binder material 1014 and/or one or more than one conductive additive material 1015) in physical contact with the protection layer 304, an ion-conductive separator 1040, a liquid or solid electrolyte 1050, a porous active cathode material layer 404 (including, for example, a granular active cathode material 1022a, one or more than one binder material 1024 and/or one or more than one conductive additive material 1025), a cathode foil 302.

Optionally, the cathode foil 302 may be an additional aluminum foil 302. Optionally, the cathode foil 302 may have a protection layer 304 in physical contact with the active cathode material layer 404. Optionally, the cathode 1022 may include the porous active cathode material layer 404 in physical contact with, if present, the protection layer 304 of the cathode foil 302, or, otherwise, with the cathode foil 302.

Illustratively, an electrochemically unstable or lithiatable material (e.g. aluminum) having high electrical conductivity may be used as anode current collector and this may have been protected or may be protected by a protection layer (for example of Cu, Ti, Ni, TiN, or the like). The material of the protection layer (also referred to as protective material) may be characterized here in that it, illustratively, does not form any compound with lithium. The protection layer may be an impervious, compact layer, optionally having high electrical conductivity.

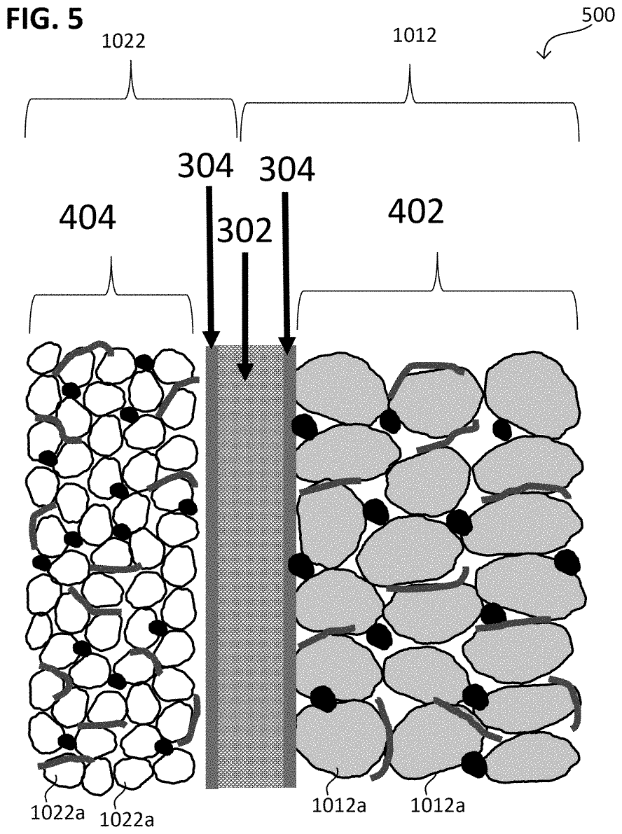

FIG. 5 illustrates a bipolar electrode arrangement 500, for example for an energy storage, in various embodiments in a schematic side view or a schematic cross-sectional view.

The bipolar electrode arrangement 500 may include the aluminum-containing foil 302 disposed between an active anode material layer 402 and an active cathode material layer 404. The foil 302 may provide, for example, the cathode foil 302 and/or the anode foil of the energy storage cell 200, 300 or 400.

In addition, the bipolar electrode arrangement 500 may include the anode foil protection layer 304 disposed between the anode foil 302 and the active anode material layer 402. The anode foil protection layer 304 may be in physical contact, for example, with the aluminum in the foil 302 and/or with the active anode material layer 402. The anode foil protection layer 304 may have been configured, for example, as described above, for example for the energy storage cell 200, 300 or 400.

Illustratively, such a bipolar electrode arrangement 500 may provide a common current collector 302 for the anode 1012 and the cathode 1022. This makes it possible to save even more weight and volume per cell.

For example, the foil 302 together with the active cathode material layer 402 may provide the cathode 1022 and, together with anode foil protection layer 304 and the active anode material layer 402, may provide the anode 1012. Illustratively, only one foil may be required for provision of the cathode 1022 and the anode 1012.

For example, a distance of the active cathode material layer 404 from the active anode material layer 402 may be less than twice the thickness of the foil 302, for example less than 40 μm, for example less than about 35 μm, for example less than about 30 μm, for example less than about 25 μm, for example less than about 20 μm. Alternatively or additionally, the foil 302 may, for example, be in one-piece (i.e. monolithic) form.

Optionally, the bipolar electrode arrangement 500 may include the cathode foil protection layer 304 disposed between the foil 302 and the active cathode material layer 404. The cathode foil protection layer 304 may be in physical contact, for example, with the aluminum in the foil 302 and/or with the active cathode material layer 404.

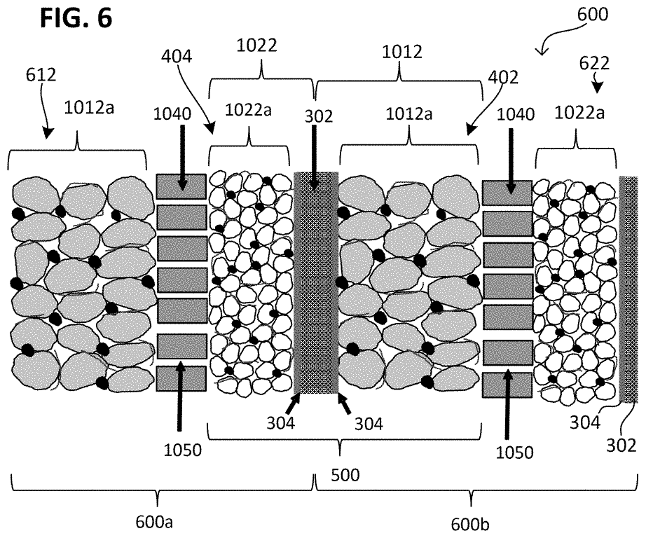

FIG. 6 illustrates an energy storage 600 in various embodiments in a schematic side view or a schematic cross-sectional view. The energy storage 600 has multiple (for example more than 2, 3, 4, 5, 20 or 40) energy storage cells 600a, 600b, for example multiple energy storage cell 200, 300 or 400.

The two energy storage cells 600a, 600b may have a bipolar electrode arrangement 500 and/or be electrically connected to one another by means of the bipolar electrode arrangement 500. For example, the two energy storage cells 600a, 600b may be contacted between the corresponding anode/cathode foil of the energy storage cells 200, 300 or 400. Alternatively or additionally, one contact connection 1012k and 1022k each may have been arranged or may be arranged at the opposite ends of the two energy storage cells 600a, 600b, which contacts a corresponding anode/cathode foil in coated form (for example on just one side).

For example, a first energy storage cell 600a may include the active cathode material layer 404 of the bipolar electrode arrangement 500 and an additional active anode material layer 612. Alternatively or additionally, a second energy storage cell 600b may include the active anode material layer 1012 of the bipolar electrode arrangement 500 and an additional active cathode material layer 622.

The foil 302 together with the anode foil protection layer 304 and optionally the cathode foil protection layer 304 may, illustratively, provide, in the bipolar electrode arrangement 600, a common current collector for multiple energy storage cells 600a, 600b. This makes it possible to save further weight and/or volume per cell.

Optionally, the additional active anode material layer 612 may be part of the first additional bipolar electrode arrangement 500. Alternatively or additionally, the additional active cathode material layer 622 may be part of a second additional bipolar electrode arrangement 500.

For example, the energy storage 600 may include a multitude of energy storage cell 600a, 600b, of which each energy storage cell has a (for example exactly one) active cathode material layer and a (for example exactly one) active anode material layer, where the energy storage cells 600a, 600b that adjoin one another in each case or are at least directly adjacent to one another have and/or are electrically connected to one another by means of a bipolar electrode arrangement 500.

For example, the energy storage 600 may have a multitude of energy storage cells 600a, 600b, of which one or more than one energy storage cell has: a (for example exactly one) active cathode material layer which is part of a bipolar electrode arrangement 500; and/or a (for example exactly one) active anode material layer which is part of a bipolar electrode arrangement 500.

For example, in this design, multiple energy storage cells 600a, 600b may be stacked directly one on top of another, such that the current collector 302, together with an anode foil protection layer 304, optionally together with a cathode foil protection layer 304, assumes the function of contact connection both of the active anode material layer and of the active cathode material layer. This means that this current collector 302 may be electrochemically stable to lithium ions or further constituents of the electrolyte both at a high electrochemical potential (for example more than 1.5 V vs. Li/Li⁺, as cathode foil) and at low electrochemical potential (for example less than 1.5 V vs. Li/Li⁺, as anode foil). By means of the protection layer on the foil 302 (for example an Al foil), this requirement on the electrochemical stability of the anode foil, for example with respect to lithium ions, may have been or may be assured.

Optionally, an additional protection layer may have been arranged or may be arranged between the protection layer 304 and the active material layers 402, 404 or the active materials 1022a, 1012a (for example active anode material (layer) and/or active cathode material (layer)). The additional protection layer may include or have been formed from carbon for example, for example in a carbon modification. This additional protection layer (for example a carbon layer) may contribute to an improvement in the properties of the electrode, but makes little or zero contribution to the passivation of the anode side of the foil 302 since the carbon, in operation of the energy storage, under some circumstances, is reversibly and/or irreversibly lithiated.

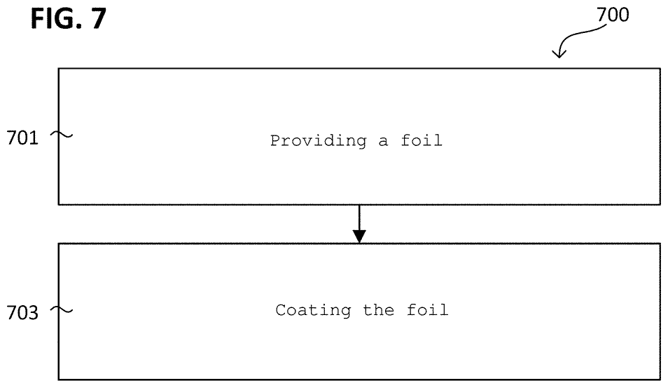

FIG. 7 illustrates a method 700 in various embodiments in a schematic flow diagram. The method 700 may include: in 701, providing a foil 302; in 703, coating the foil 302 with an active anode material layer 1012a to provide an anode 1012.

The foil 302 may include or have been formed from a first metal. The first metal of the foil 302 may be one of aluminum, tin, germanium, magnesium, lead, zinc, antimony or lithium.

The foil 302 may also have been coated with a protection material 304, for example on a first side and/or on an opposite second side from the first side (for example on both sides). The protection material 304 may include or have been formed from a second metal different than the first metal. The second metal may be one of copper, titanium and nickel.

The foil 302 may be coated with the active anode material layer 1012a for the providing of an anode 1012 on the first side or both on the first side and on the second side of the foil; for example, the protective material 304 may be disposed on the side(s) to be coated with the active anode material layer.

The method 700 may optionally include: coating the foil 302 with an active cathode material layer 404 and/or with an active cathode material 1022a for provision of a cathode 1022. The foil 302 may be coated with the active cathode material layer 404 and/or with the active cathode material 1022a only on the second side of the foil 302, or both on the second side and on the first side of the foil 302. The protective material 304 may optionally be disposed atop the foil coated with the active cathode material.

The foil 302 with the protection layer 304 may be provided, for example, by the method 100a or 100b.

There follows a description of various examples that relate to what has been described above and is shown in the figures.

Example 1 is a bipolar electrode arrangement having: a foil which includes or has been formed from a first metal, where the first metal of the foil is one of aluminum, tin, germanium, magnesium, lead, or zinc, antimony or lithium; an active anode material and an active cathode material, where the foil is disposed between the active anode material and the active cathode material; a protection material with which the foil has been coated on at least one surface (or side) facing the active anode material; where the foil together with the active cathode material provides a cathode, and together with the active anode material provides an anode.

Example 2 is the bipolar electrode arrangement according to example 1, wherein the protection material includes or has been formed from a second metal other than the first metal of the foil (e.g. aluminum).

Example 3 is an energy storage having two or more energy storage cells, of which one or more than one (for example each) pair of adjoining or at least directly adjacent energy storage cells has a bipolar electrode arrangement according to example 1 or 2, wherein the bipolar electrode arrangement provides an anode and a cathode of the pair of energy storage cells.

Example 4 is an energy storage having: an anode and a cathode, said anode having: a foil including or formed from a first metal, where the first metal of the foil is one of aluminum, tin, germanium, magnesium, lead, zinc, antimony and lithium; an active anode material having a first electrochemical potential; a protection material with which the foil has been coated, where the protection material includes or has been formed from a second metal other than the first metal of the foil; and said cathode having: an active cathode material having a second electrochemical potential different than the first chemical potential.

Example 5 is the energy storage or the bipolar electrode arrangement according to any of examples 1 to 4, wherein the active anode material or the active cathode material includes lithium (e.g. Li/Li+) (for example contains lithium, for example is metallic and/or for example is formed from elemental lithium or from a compound including lithium).

Example 6 is the energy storage or the bipolar electrode arrangement according to any of examples 1 to 5, wherein the active cathode material includes sulfur.

Example 7 is the energy storage or the bipolar electrode arrangement according to any of examples 1 to 6, wherein the active anode material is disposed on mutually opposite sides of the foil; and/or wherein the active cathode material is disposed on mutually opposite sides of the foil.

Example 8 is the energy storage or the bipolar electrode arrangement according to any of examples 1 to 7, wherein the active anode material has been provided by means of (for example as part of) an active anode material layer, and the active cathode material by means of (for example as part of) an active cathode material layer.

Example 9 is the energy storage or the bipolar electrode arrangement according to example 8, wherein the foil is disposed between the active anode material layer and the active cathode material layer; and/or wherein the foil has been coated with the protection material on at least one surface (or side) facing the active anode material layer; and/or wherein the foil together with the active cathode material layer provides a cathode, and together with the active anode material layer provides an anode.

Example 10 is the energy storage or the bipolar electrode arrangement according to any of examples 1 to 9, wherein the protection material has a greater electrochemical stability with respect to lithium (e.g. Li/Li+) and/or an electrochemical stability of less than 1.5 V with respect to lithium (Li/Li+) than an oxide of the first metal of the foil (e.g. aluminum oxide or tin oxide); and/or wherein the protection material has a greater electrochemical stability window (for example a greater margin between the limiting voltages) with respect to lithium (e.g. Li/Li+) than an oxide of the first metal of the foil (e.g. aluminum oxide or tin oxide), where the electro chemical stability window is optionally disposed below 1.5 V with respect to lithium (Li/Li+).

Example 11 is the energy storage or the bipolar electrode arrangement according to any of examples 1 to 10, wherein the protection material is in physical contact with the active anode material; and/or wherein the protection material is in physical contact with the first metal of the foil.

Example 12 is the energy storage or the bipolar electrode arrangement according to any of examples 1 to 11, also including: an electrolyte including lithium (e.g. Li/Li+).

Example 13 is the energy storage according to any of examples 1 to 12, wherein the energy storage is an energy storage of the rechargeable type; and/or wherein the energy storage is an accumulator.

Example 14 is the energy storage or the bipolar electrode arrangement according to any of examples 1 to 13, wherein an extent of the protection material (e.g. layer thickness) with which the film has been coated is less than a parallel extent of the active anode material.

Example 15 is the energy storage or the bipolar electrode arrangement according to any of examples 1 to 14, wherein the active anode material includes or has been formed from graphite, silicon, lithium, and/or aluminum.

Example 16 is the energy storage or the bipolar electrode arrangement according to any of examples 1 to 15, wherein the active anode material includes or has been formed from aluminum.

Example 17 is the energy storage or the bipolar electrode arrangement according to any of examples 1 to 16, wherein the active anode material includes or has been formed from silicon.

Example 18 is the energy storage or the bipolar electrode arrangement according to any of examples 1 to 17, wherein the active anode material includes or has been formed from graphite.

Example 19 is the energy storage or the bipolar electrode arrangement according to any of examples 1 to 18, wherein the active anode material includes or has been formed from lithium.

Example 20 is the energy storage or the bipolar electrode arrangement according to any of examples 1 to 19, wherein the active anode material includes or has been formed from tin.

Example 21 is the energy storage or the bipolar electrode arrangement according to any of examples 1 to 20, wherein the active anode material includes or has been formed from zinc, germanium, magnesium, lead and/or antimony.

Example 22 is the energy storage or the bipolar electrode arrangement according to any of examples 1 to 21, wherein the active anode material is free of titanium or a titanate.

Example 23 is the energy storage or the bipolar electrode arrangement according to any of examples 1 to 22, wherein the active anode material is metallic.

Example 24 is the energy storage or the bipolar electrode arrangement according to any of examples 1 to 23, wherein the active cathode material includes or has been formed from lithium-iron phosphate.

Example 25 is the energy storage or the bipolar electrode arrangement according to any of examples 1 to 24, wherein the active cathode material includes or has been formed from lithium-nickel-manganese-cobalt oxide.

Example 26 is the energy storage or the bipolar electrode arrangement according to any of examples 1 to 25, wherein the protection material is a metallic material.

Example 27 is the energy storage or the bipolar electrode arrangement according to any of examples 1 to 26, wherein the protection material or the second metal includes or has been formed from copper.

Example 28 is the energy storage or the bipolar electrode arrangement according to any of examples 1 to 27, wherein the protection material or the second metal includes or has been formed from titanium (e.g. TiN).

Example 29 is the energy storage or the bipolar electrode arrangement according to any of examples 1 to 28, wherein the protection material or the second metal includes or has been formed from nickel.

Example 30 is the energy storage or the bipolar electrode arrangement according to any of examples 1 to 29, wherein the active anode material and/or the active cathode material are porous and/or granular; and/or wherein the active anode material and/or the active cathode material are lithiatable (for example at a voltage of more than 3.5 V or more than 4 V).

Example 31 is the energy storage or the bipolar electrode arrangement according to any of examples 1 to 30, wherein the active anode material and/or the active cathode material has a greater porosity than the protective material (for example the layer formed therefrom) and/or than the foil, or wherein the active anode material has a lithium layer.

Example 32 is the energy storage or the bipolar electrode arrangement according to any of examples 1 to 31, wherein the protection material provides a layer (also referred to as protection layer) atop the foil that separates the active anode material and the foil from one another in a fluid-tight and/or lithium ion-tight manner.

Example 33 is the energy storage or the bipolar electrode arrangement according to any of examples 1 to 32, wherein the protection material is free of the first metal of the foil (e.g. aluminum, tin, germanium, magnesium, lead, zinc, antimony or lithium), free of an alloy that includes the metal, free of a lithium compound-forming material and/or free of carbon.

Example 34 is the energy storage or the bipolar electrode arrangement according to any of examples 1 to 33, further including: an encapsulation that surrounds the anode and/or the cathode and/or has a cavity in which the anode and the cathode are disposed.

Example 35 is the energy storage or the bipolar electrode arrangement according to any of examples 1 to 34, further including: a first exposed contact connection that contacts the anode and/or a second exposed contact connection that contacts the cathode.

Example 36 is the energy storage or the bipolar electrode arrangement according to any of examples 1 to 35, wherein the cathode includes a foil including a metal.

Example 37 is the energy storage or the bipolar electrode arrangement according to any of examples 1 to 36, wherein the cathode includes an additional foil that includes the first metal of the foil (e.g. aluminum or lithium, tin, germanium, magnesium, lead, zinc, antimony or lithium) or a third metal, where the third metal of the additional foil is one of aluminum, tin, germanium, magnesium, lead, zinc, antimony or lithium.

Example 38 is the energy storage or the bipolar electrode arrangement according to any of examples 1 to 37, wherein the cathode includes a or the additional foil and an additional protection material, wherein the additional foil has been coated with the additional protection material, and wherein the additional protection material is optionally in contact with the active cathode material, and wherein the additional protection material optionally differs from the protection material.

Example 39 is the energy storage or the bipolar electrode arrangement according to any of examples 1 to 38, wherein the foil has been coated with the protection material on both sides, for example has a coating of the protection material on both sides.

Example 40 is the energy storage or the bipolar electrode arrangement according to any of examples 1 to 39, wherein the first electrochemical potential, with respect to lithium (e.g. Li/Li+, i.e. with lithium as reference), has a voltage of less than about 1.2 V (for example than about 1 V, for example than about 0.8 V, for example than about 0.5 V, for example than about 0.3 V, for example than about 0.1 V).

Example 41 is the energy storage or the bipolar electrode arrangement according to any of examples 1 to 40, wherein the second electrochemical potential, with respect to lithium (e.g. Li/Li+, i.e. with lithium as reference), has a voltage of greater than about 3.0 V (for example than about 3.5 V, for example than about 4 V) and/or less than or equal to 4.3 V.

Example 42 is the energy storage or the bipolar electrode arrangement according to any of examples 1 to 41, wherein an electrochemical potential difference between the cathode and the anode is greater than about 3.0 V (for example than about 4 V, than about 4.2 V) and/or less than 4.3 V.

Example 43 is the energy storage or the bipolar electrode arrangement according to any of examples 1 to 42, further including: a separator disposed between the active anode material and the active cathode material, for example insulating these from one another (for example electrically separating them from one another), wherein the separator is ion-conductive, for example, and/or is penetrated by the (for example lithium ion-conductive) electrolyte.

Example 44 is the energy storage or the bipolar electrode arrangement according to any of examples 1 to 43, wherein the foil is disposed between the active anode material and the active cathode material.

Example 45 is the energy storage or the bipolar electrode arrangement according to any of examples 1 to 44, wherein the foil connects the active cathode material and the active anode material to one another in an electrically conductive manner.

Example 46 is the energy storage or the bipolar electrode arrangement according to any of examples 1 to 45, wherein the foil together with the active cathode material provides the cathode, and together with the active anode material provides the anode.

Example 47 is the energy storage or the bipolar electrode arrangement according to any of examples 1 to 46, wherein the foil has the first metal on a surface coated with the protective material.

Example 48 is the energy storage or the bipolar electrode arrangement according to any of examples 1 to 47, wherein the foil includes a laminate or composite material.

Example 49 is the energy storage or the bipolar electrode arrangement according to any of examples 1 to 48, wherein the foil is a metal foil.

Example 50 is the energy storage or the bipolar electrode arrangement according to any of examples 1 to 49, wherein the foil has a carrier made of a polymer.

Example 51 is the energy storage or the bipolar electrode arrangement according to any of examples 1 to 50, wherein a distance between the active anode material and the active cathode material is less than an extent of the active anode material and/or of the active cathode material in the distance direction.

Example 52 is the energy storage or the bipolar electrode arrangement according to any of examples 1 to 51, wherein the foil is thinner than 40 μm (for example than 20 μm).

Example 53 is the energy storage or the bipolar electrode arrangement according to any of examples 1 to 52, wherein the foil has been coated with the active cathode material and with the active anode material (such that it has been coated with active material on two sides).

Example 54 is a method (for example of producing the energy storage or the bipolar electrode arrangement according to any of examples 1 to 53), said method including: providing a foil which includes or has been formed from a first metal and has been coated with a protection material (for example on exactly one side or two sides), wherein the protection material includes or has been formed from a second metal other than the first metal; coating the foil, on at least one side of the foil on which the protection material has been disposed, with an active anode material to provide an anode, where the first metal of the foil is one of aluminum, tin, germanium, magnesium, lead, zinc, antimony and lithium; and optionally coating the foil, on at least one opposite side of the foil from the active anode material on which the protection material has optionally been disposed, with an active cathode material for provision of a cathode.

Example 55 is the use of a foil which includes or has been formed from a first metal and has been coated with a protection material for formation of an anode, wherein the protection material includes a second metal other than the first metal, wherein the first metal of the foil is one of aluminum, tin, germanium, magnesium, lead, zinc, antimony and lithium.

What is claimed is:

1. An energy storage having:
an anode and a cathode,
said anode having:
a foil including a first metal, where the first metal of the foil is one of aluminum, tin, germanium, magnesium, lead, zinc, antimony and lithium;
an active anode material having a first electrochemical potential;
a protection material with which the foil has been coated, where the protection material comprises a second metal other than the first metal;
said cathode having:
an active cathode material having a second electrochemical potential different than the first chemical potential;
wherein the active anode material or the active cathode material comprises lithium.

2. The energy storage as claimed in claim 1,
wherein the protection material has a greater electrochemical stability with respect to lithium than an oxide of the first metal.

3. The energy storage as claimed in claim 1,
wherein the protection material is in physical contact with the active anode material.

4. The energy storage as claimed in claim 1, further having:
an electrolyte comprising lithium ions.

5. The energy storage as claimed in claim 1,
wherein an extent of the protection material with which the foil has been coated is less than a parallel extent of the active anode material.

6. The energy storage as claimed in claim 1,
wherein the protection material comprises copper.

7. The energy storage as claimed in claim 1,
wherein the protection material comprises titanium.

8. The energy storage as claimed in claim 1,
wherein the protection material comprises nickel.

9. The energy storage as claimed claim 1,
wherein the active anode material and/or the active cathode material has a greater porosity than the protection material; or
wherein the active anode material has a lithium layer.

10. The energy storage as claimed in claim 1,
wherein the storage material provides a layer on the foil that separates the active anode material and the foil from one another in a fluid-tight and/or lithium ion-tight manner.

11. The energy storage as claimed in claim 1,
wherein the protection material is free of the first metal and/or carbon.

12. The energy storage as claimed in claim 1,
wherein the foil together with the active cathode material provides the cathode, and together with the active anode material provides the anode.

13. A bipolar electrode arrangement having:
a foil comprising a first metal, where the first metal of the foil is one of aluminum, tin, germanium, magnesium, lead, zinc, antimony and lithium;
an active anode material and an active cathode material, wherein the foil is disposed between the active anode material and the active cathode material;
a protection material with which the foil has been coated on at least one surface facing the active anode material;
wherein the foil together with the active cathode material provides a cathode, and together with the active anode material provides an anode.

14. A method, said method comprising:
providing a foil comprising a first metal, where the first metal of the foil is one of aluminum, tin, germanium, magnesium, lead, zinc, antimony or lithium, and which has been coated with a protection material, where the protection material comprises a second metal other than the first metal;
coating the foil on at least one side of the foil on which the protection material is disposed with an active anode material for provision of an anode.
